(19) United States
(12) Patent Application Publication
(10) Pub. No.: US 2015/0217286 A1
(43) Pub. Date: Aug. 6, 2015

(54) CATALYTICALLY EFFECTIVE COMPOSITION HAVING A LARGE CO SURFACE AREA

(71) Applicant: Heraeus Precious Metals GmbH & Co. KG, Hanau (DE)

(72) Inventors: Ansgar WILLE, Hanau-Mittelbuchen (DE); Marcus BONIFER, Offenbach (DE); Martina KEMMER, Kahl am Main (DE)

(21) Appl. No.: 14/614,843

(22) Filed: Feb. 5, 2015

(30) Foreign Application Priority Data
Feb. 6, 2014 (EP) 14 154 155.7

(51) Int. Cl. B01J 37/16; B01J 23/10; B01J 35/10; B01J 23/44

(52) U.S. Cl. CPC B01J 37/16; B01J 23/44; B01J 23/10; B01J 35/1009

(57) ABSTRACT

The present invention relates to a method for producing a catalytically effective composition for catalysts, to the compositions obtained in the method, and to catalysts containing the composition.

### BACKGROUND OF THE INVENTION

The present invention relates to a method for producing a catalytically effective composition for catalysts, to the compositions obtained in the method, and to catalysts containing the composition.

It has long been customary, especially with regard to motor vehicles, to subject the exhaust gas of a combustion motor to after-treatment using a catalyst. The task of the catalyst is to convert the pollutants generated during combustion, i.e., hydrocarbons (CₘHₙ), carbon monoxide (CO), and nitrogen oxides (NOₓ), into the non-toxic substances carbon dioxide (CO₂), water (H₂O), and nitrogen (N₂). The following oxidation and reduction reactions take place in this process:

2CO+O₂→2CO₂

2C₂H₆+7O₂→4CO₂+6H₂O

2NO+2CO→N₂+2CO₂

There are various types of catalysts. The best-known, aside from the three-way catalyst, are oxidation catalysts and NOₓ storage catalysts.

The three-way catalyst, also referred to as a controlled catalyst or “G-Kat,” has become standard equipment in a motor vehicle fitted with a combustion engine. In this context, the term “controlled” refers to the motor management of the combustion. The three-way catalyst can only be used in vehicles equipped with a combustion engine and lambda control. In a three-way catalyst, the oxidation of CO and HₘCₙ and the reduction of NOₓ take place in parallel. This requires a constant air-fuel mixture at a stoichiometric ratio of lambda (λ) equal to 1.

In a combustion engine, the lambda probe ensures controlled combustion of the fuel. The lambda probe is used to determine the air-fuel ratio in the exhaust gas of the combustion engine. The measurement is based on the residual oxygen content present in the exhaust gas. The lambda probe is the main sensor in the control loop of the lambda control for catalytic after-treatment with a controlled catalyst and supplies the measured value to the motor control unit.

The lambda control establishes a desired lambda value in the exhaust gas of a combustion engine. In this context, lambda denotes the air-fuel ratio, which is the ratio of the mass of air available for combustion to the minimal stoichiometric mass of air required for complete combustion of the fuel. At the stoichiometric fuel ratio, exactly the amount of air required for complete combustion of the fuel is present. This is called λ=1. If more fuel is present, the mixture is called rich (λ<1), whereas an excess of air being present corresponds to a lean mixture (λ>1). If there is any deviation from the stoichiometric air-fuel ratio towards an excess of air, i.e., lean region, not all nitrogen oxides are decomposed, since the requisite reducing agents are being oxidized earlier. In the rich region, i.e., air deficit, not all hydrocarbons and not all of the carbon monoxide are decomposed.

The air-fuel equivalence ratio lambda, also called “air excess,” air excess number,” or “air ratio” for short, is a parameter of combustion technology. This parameter provides some feedback concerning the progress of the combustion, temperatures, generation of pollutants, and the efficiency. Proper fine-tuning of carburetor or fuel injection facility, and thus the adjustment of lambda, has a major impact on motor performance, fuel consumption, and the emission of pollutants.

Combustion engines are usually controlled to a narrow range of approx. 0.97<λ<1.03. The range within these thresholds is called the lambda window. The best reduction of all three types of pollutants is attained within this window. At high motor performance, operating the engine with a rich mixture, and therefore colder exhaust gas, prevents the exhaust components, such as manifold, turbo-charger, and catalyst, from overheating.

To attain a value of λ=1 in operation, sufficient oxygen must be available in the catalyst in order to carry out the oxidation-reduction reactions indicated above. On the other hand, oxygen released during the reduction must be bound for the reduction of the nitrogen oxides to nitrogen to take place. Three-way catalysts usually contain an oxygen reservoir that is charged with oxygen at oxidizing conditions and can release oxygen again at reducing conditions.

In addition to the oxygen reservoir, a catalyst often also comprises at least one noble metal; usually this will be platinum, palladium, and/or rhodium. If aluminum oxide is also used in a catalyst, it is important to ensure that the rhodium does not become applied onto the aluminum oxide. At elevated temperatures, the rhodium adsorbs to the porous structure of the aluminum oxide and is therefore no longer available for the actual catalytic reaction. Accordingly, EP 1053779 A1 describes a catalyst in which the catalytically active layer comprises a cerium complex oxide and a zirconium complex oxide. While palladium is situated on the cerium complex oxide, platinum and rhodium are applied onto the zirconium complex oxide.

In this context, noble metals are applied onto a substrate material and form active centers on the surface of the catalyst. In order to attain a high conversion rate for a catalyst, it is desirable to have as many active noble metal centers present as possible and to have these centers distributed over the surface as evenly as possible. Since the noble metals in catalysts are usually present in the form of approximately spherical particles on the surface of the substrate material, it is also advantageous for the particles to have the smallest possible diameter. At a given total amount of noble metal applied, this results in a large number of noble metal particles which comprise a large surface, i.e., a contact surface on which a reaction can take place. This applies not only to the exhaust gas catalysts described extensively in the prior art, but also to other catalysts which are used, for example, in the synthesis of different compounds.

In order to distribute the noble metals on the substrate as evenly as possible, it is important to look for good distribution of the noble metal during the production thereof. It is therefore customary to dissolve the noble metal in the form of a salt and to apply it onto a substrate material. Accordingly, for example EP 2 524 727 A1 describes, in an exemplary embodiment, dissolving ruthenium trichloride in ethylene glycol. The solution is then mixed with the substrate material. EP 2022 562 A1 and US 2009/022643 A1 describe the use of a solution containing 0.4 mol ruthenium per liter, which is used for coating of a substrate structure.

The number of active noble metal centers can be determined, for example, by means of CO chemisorption. For this purpose, a catalyst is oxidized in a closed container for 20 minutes at 400° C. in synthetic air consisting of 80% nitrogen and 20% oxygen. Subsequently, the container, and therefore the catalyst as well, are rinsed with nitrogen until no more oxygen flows from the container and/or until no more oxygen is detected in the out-flowing gas.

Pulsed doses of carbon monoxide (CO) are added into the container containing the catalyst. This is continued until constant CO peaks are detected downstream of the catalyst. The amount of CO taken up by the catalyst may be determined by determining the peak area of the dosed CO and the peak area of the converted CO. For this purpose, the integral of the area of converted CO is subtracted from the integral of the peak of dosed CO.

The amount of CO taken up thus determined is then used to calculate how much CO was stored per added quantity of catalytically active composition. Conversions may be used to determine the surface area of the active noble metal centers (often called the CO surface area or noble metal surface) from the measured amount of CO stored on the active centers. This is reported in units of m²/g.

The oxygen storage capacity of a material may also be determined by CO chemisorption. For this purpose, the sample to be analyzed is first fully oxidized with oxygen at a certain temperature (350° C.). Then the sample is exposed to “pulses” (CO doses) of CO until more no oxygen for oxidation of CO in the gas remains in the sample. The gas flowing through the sample to be analyzed is then detected. Analysis of the area under the peaks in the detection process allows the amount of converted CO to be determined, which is a measure of the oxygen storage capacity. The oxygen storage capacity is therefore reported in units of μmol CO per gram of catalytically effective composition.

A determination of the CO surface area of conventional commercial catalysts in the automotive industry shows that these usually comprise a CO surface area of 6 m²/g or less.

For improvement of the catalytic activity of a catalyst, there is a need to have catalysts with the largest possible number of active noble metal centers, i.e., a large CO surface area, which are capable of reducing the emission of CO, HC, and NOₓ as compared to known catalysts both in rich and in lean motor operation. Especially in motorcycles, the fluctuation of in operation of the motor can go beyond the common range for petrol engines of 0.97<λ<1.03. It is necessary in this case to have the catalyst still work properly and convert exhaust gases accordingly even if the deviation from λ=1 is larger, in particular in the range of 0.8<λ<1.2. However, catalysts with an increased activity as compared to the prior art are sought after not only in the field of exhaust gas after-treatment of combustion motors, but also, for example, in the synthesis of chemical substances.

### BRIEF SUMMARY OF THE INVENTION

It is therefore the object of the present invention to provide a catalytically effective composition for a catalyst that has a larger number of active noble metal centers as compared to the prior art. Moreover, the catalyst shall be capable of balancing out lambda fluctuations arising during the exhaust gas after-treatment of combustion motors.

A method for producing a catalytically effective composition for catalysts comprises:
a) providing a first oxidic substrate material;
b) providing a noble metal salt solution containing one or more noble metal salts in, wherein a concentration of noble metal in the solution is 0.01 wt. % or less, relative to the total solution being 100 wt. %;
c) producing a suspension by contacting the first oxidic substrate material with the noble metal salt solution; and
d) introducing a second oxidic substrate material into the suspension obtained in step c).

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIGS. 1 and 2 show scanning electron micrographs (SEMs), in which the particle size d90 of the second catalytically effective composition is higher than 35 μm;

FIG. 3 schematically shows the design of a multilayer catalyst according to an embodiment of the invention having a substrate structure, a first layer (1), and a second layer (2); and

FIG. 4 shows a preferred embodiment, in which the arrow indicates the flow direction of the exhaust gas to be treated.

### DETAILED DESCRIPTION OF THE INVENTION

Therefore, the underlying object of the present invention is met in a first embodiment by a method for producing a catalytically effective composition for catalysts, comprising the following steps:
a) providing a first oxidic substrate material;
b) providing a noble metal salt solution containing one or more noble metal salts, wherein the concentration of noble metal in the solution is 0.01 wt. % or less relative to the total solution being 100 wt. %;
c) producing a suspension by contacting the first oxidic substrate material from step a) with the noble metal salt solution from step b); and
d) introducing a second oxidic substrate material into the suspension obtained in step c).

Surprisingly, it has been found that the production of a catalytically effective composition with a noble metal concentration in the solution of 0.01 wt. % or less, in particular 0.008 wt. % or less, particularly preferably 0.007 wt. % or less, each relative to the total solution being 100 wt. %, enables the production of a composition that has a CO surface area of 6 m²/g or more, preferably 7 m²/g or more, particularly preferably 7.5 m²/g or more. The CO surface area is determined using the method described above and is reported in units of m² per gram of catalytically effective composition. By increasing the CO surface area relative to the prior art, the composition, and therefore catalysts containing the composition, comprise an increased number of active metal centers as compared to conventional catalysts. This leads to a larger active surface, which increases the activity of the catalyst.

In order to obtain a noble metal salt solution having a noble metal concentration of 0.01 wt. % or less, a conventional noble metal salt solution may be diluted accordingly. Noble metal salt solutions usually contain a noble metal concentration equal to a fraction of approx. 14 wt. %. In order to obtain a concentration according to the invention, a solution of this type is to be diluted approximately 1,000-fold. This leads not only to a reduction in the concentration of the noble metal in the solution, but also to a marked increase in the volume of the noble metal salt solution. Dilutions in which the noble metal salt solution is diluted by a factor of 3,000 (corresponding to a fraction of 0.00175 wt. % of noble metal in the solution) or more can no longer be used economically in the method according to the invention. In order to obtain the desired or required total quantity of noble metal in the catalytically effective composition, the suspension obtained in step c) comprises such a large volume, at a dilution of 3,000-fold, that further processing is no longer economical.

In the present disclosure, the term suspension refers to a mixture of a solid and a liquid, in which the solid is present in the form of fine-distributed solids that are evenly distributed in the liquid.

According to the invention, the first and the second oxidic substrate materials may be the same or different from each other. Accordingly, the first and/or the second oxidic substrate materials may be selected from the group consisting of aluminum oxide, cerium-zirconium oxide, barium oxide, tin oxide, and titanium oxide.

The substrate materials are selected as a function of the later application of the catalytically effective composition obtained according to the method of the invention. If the composition is used, for example, in a catalyst for a combustion engine, the first and/or the second oxidic substrate material is preferably selected from aluminum oxide and/or a cerium-zirconium oxide. If another chemical reaction is to be catalyzed by the composition, barium oxide, tin oxide, and titanium oxide have proven to be well-suited substrate materials.

The first and/or second oxidic substrate materials of the composition comprises one or more of the afore-mentioned materials. Preferably, it consists of one of the afore-mentioned oxides. According to the invention, the oxides may be doped with other. Accordingly, cerium-zirconium oxide may be doped, for example, with lanthanum oxide, praseodymium oxide, neodymium oxide and/or hafnium oxide. In this context, the fraction of the respective metal oxides may be 2 wt. % to 10 wt. %, preferably 3 wt. % to 7 wt. %, relative to the cerium-zirconium oxide being 100 wt. %. Doping at the levels indicated leads to the cerium-zirconium oxide showing improved thermal stability. If the fraction is lower, no effect is detectable. Higher fractions of more than 10 wt. % do not increase the stability any further.

According to the present invention, the cerium-zirconium oxide may be either a mixed oxide of cerium and zirconium or a mixture of the two oxides, cerium oxide CeO₂ and zirconium oxide ZrO₂. According to the invention, the cerium-zirconium oxide comprises both cerium-rich oxides and zirconium-rich oxides.

Usually, gamma-aluminum oxide (γ-Al₂O₃) is used as aluminum oxide. Preferably, this substance is doped with lanthanum oxide La₂O₃. Using the composition produced according to the invention in a catalyst, the γ-Al₂O₃ has an influence on the adhesion of the composition on the surface of a catalyst substrate, provided that the composition is to be applied onto a substrate of this type.

The γ-Al₂O₃ preferably has a particle size d90 in the range of 10 μm to 35 μm, more preferably in the range of 15 μm to 30 μm, particularly preferably in the range of 19 μm to 24 μm. This substance may also be added to the composition according to the invention without grinding so that as before, no grinding step is required. It has surprisingly been found that the exhaust gas treatment was improved by the composition made up of non-ground components as compared to a composition made up of ground components.

In the present application, the terms, “particle size” and “particle size distribution” are used as synonyms and each refers to the particle size distribution determined with a CILAS 920 laser granulometer of Quantachrome (Odelzhausen, Germany) in accordance with ISO 13320. A low-energy laser diode with 3 mW power and a wavelength of 830 nm was used in the measurement.

The γ-Al₂O₃ preferably has a large BET surface area. The BET surface area of γ-Al₂O₃ is usually approx. 200 m²/g. At high temperatures as arise, for example, during sintering during the production or in operation of a catalyst, this value decreases to approx. 40 to 50 m²/g. Doping with lanthanum oxide achieves higher thermal stability of γ-Al₂O₃. Even after thermal treatment, the BET surface area of γ-Al₂O₃ doped according to the invention is still in a range of more than 70 m²/g, particularly preferably 90 m²/g.

The BET surface area is also referred to as specific surface area and may be determined according to the BET method that is known according to the prior art. In the measurement, a gas, often nitrogen, is guided across the material to be tested. The BET equation is used to calculate from an adsorbed amount of gas the amount of adsorbate that forms a layer, the so-called monolayer, on the surface of the tested object. The BET surface area is equivalent to the number of mol Vm in the monolayer multiplied by Avogadro's number N_{A} and the space needs of a gas molecule (nitrogen: aₘ=0.162 nm²).

Table 1 below shows the CO surface area of a catalytically effective composition produced according to a method known in the prior art. This composition, denoted composition 1 (comp. 1), has a CO surface area of 5.7 m²/g. A composition (comp. 2), which also was not produced according to the invention, even has a CO surface area of just 1.6 m²/g. In contrast, a catalytically effective composition (comp. 4) produced according to the method according to the invention has a CO surface area of 7.8 m²/g or 12.4 m²/g (comp. 3).

The total amount of noble metal contacted to the first oxidic substrate material is 1.65 wt. % in either case, relative to the total weight of the first oxidic substrate material and noble metal being 100 wt. % (column 3 in Table 1). The last column then shows the respective concentration of noble metal in the noble metal salt solution.

The CO surface area was determined in accordance with the description provided above. For this purpose, 150 g/L of the catalytically effective composition produced according to the invention were applied to a honeycomb structure as the substrate structure. In this context, the unit “g/L” refers to grams of the catalytically effective composition applied per liter of void volume of the substrate structure. The substrate structures coated with the composition were then subjected to further analysis as described above. The results of the measurements are shown in column 5 of Table 1.

TABLE 1

| | | | 1st and 2nd | | |
|---|---|---|---|---|---|
| | | Total amount | oxidic | | Concentration |
| | | of noble | substrate | CO surface | of noble metal |
| Composition | Noble metal | metal applied | material | area [m²/g] | salt solution |
| Comp. 1 | Pd | 1.65 wt. % | 1.: No. 5 | 5.7 | 7 wt. % |
| (non-inventive) | | | 2.: No. 2 | | |
| Comp. 2 | Pd | 1.65 wt. % | 1.: No. 3 | 1.6 | 7 wt. % |
| (non-inventive) | | | 2.: No. 2 | | |
| Comp. 3 | Pd | 1.65 wt. % | 1.: No. 3 | 12.4 | 0.002 wt. % |
| (inventive) | | | 2.: No. 2 | | |
| Comp. 4 | Pd | 1.65 wt. % | 1.: No. 5 | 7.8 | 0.002 wt. % |
| (inventive) | | | 2.: No. 2 | | |

Column 4 of Table 1 shows the first and the second oxidic substrate material, in which the first oxidic substrate material of the composition is always specified first, followed by the second oxidic substrate material of the composition. Each of the compositions uses 70 wt. % of the first oxidic substrate material and 30 wt. % of the second oxidic substrate material, such that the sum of the first and second oxidic substrate materials, excluding the noble metal/noble metals, adds up to 100 wt. %. The composition of the oxidic substrate materials is described in Table 2 below. The specifications are given in units of wt. % unless noted otherwise.

TABLE 2
Oxidic substrate materials

| | Oxidic substrate material | | | | | | | |
|---|---|---|---|---|---|---|---|---|
| | CeO₂ | ZrO₂ | La₂O₃ | Pr₆O₁₁ | Nd₂O₃ | Al₂O₃ | La₂O₃ | BET [m²/g] |
| No. 1 | 60 | 30 | 3 | 7 | | | | 49 |
| No. 2 | | | | | | 97.1 | 2.9 | 131 |
| No. 3 | 74.5 | 25.5 | | | | | | 190 |
| No. 4 | 20 | 73 | 2 | | 5 | | | 109 |
| No. 5 | 68 | 24 | 8 | | | | | 94 |

It is preferable to provide a total amount of noble metal in the range of 0.01 wt. % to 10 wt. %, more preferably 0.1 wt. % to 5 wt. %, particularly preferably 0.2 wt. % to 2 wt. %, to be contacted to the first oxidic substrate material in step c), relative to the total amount of first oxidic substrate material and noble metal being 100 wt. %. Accordingly, the total amount of noble metal present in the catalytically effective composition produced according to the invention is therefore in ranges that are also described in the prior art. The difference from the prior art is in the production method, in which the concentration of noble metal in the solution in which it is provided is 0.01 wt. % or less, preferably 0.008 wt. % or less, particularly preferably 0.007 wt. % or less. This leads to the production of a composition that comprises a larger number of catalytically active noble metal centers on the surface as compared to the prior art. Surprisingly, it has been found that the concentration of the noble metal salt solution is crucial for obtaining a larger CO surface area as compared to the prior art, and therefore for obtaining an improved catalytic activity of a catalytically effective composition.

It is feasible, according to the invention, to contact the first oxidic substrate material with one noble metal salt. However, it is also feasible to contact the substrate material with two, three or more noble metal salts. For this purpose, the noble metal salts are preferably selected from the group of the salts of platinum group metals, particularly preferably from the group consisting of the salts of platinum, palladium, and rhodium. The noble metals are preferably used in the form of the nitrate salts thereof. These are inexpensive to obtain and easy to process.

It has been found that platinum group metals and, in particular, platinum, palladium, and rhodium, catalyze a broad range of methods particularly effectively. Using platinum and/or rhodium in a catalyst for after-treatment of exhaust gases of combustion engines, it has been found that platinum and/or rhodium being present in the composition facilitates rapid incorporation and retrieval of oxygen in and from a suitable first oxidic substrate material, such as, for example, cerium-zirconium oxide. When the exhaust gas to be treated contacts the composition produced according to the invention, nitrogen oxides may be reduced rapidly by removing the oxygen from the reaction equilibrium and storing it in the oxygen reservoir.

In contrast, palladium provides for slower incorporation and retrieval of oxygen into and from a suitable first oxidic substrate material, such as, for example, cerium-zirconium oxide. However, the use of palladium increases the oxygen storage capacity of the oxidic substrate material.

In order to attain a homogeneous distribution of active noble metal centers on the oxidic substrate material, it is preferred to use, in step c) during the production of the suspension, a liquid in which both the first and the second oxidic substrate materials form a suspension. Moreover, the noble metal salt solution should be miscible at any ratio with this liquid. Therefore, it is preferable to use a hydrophilic liquid, in particular water, for the production of the suspension. A suspension of oxidic substrate materials in water may be made well and easily. The preferred noble metal salts are soluble in water such that an aqueous solution may be provided in step b). Accordingly, the noble metal salt solution is miscible with the liquid of the suspension at any ratio. Moreover, water is inexpensive and undesired side reactions may be virtually prevented.

The contacting in step c) of the method according to the invention takes place, for example, by adding the noble metal salt solution to a suspension of the first oxidic substrate material in a hydrophilic solvent, followed by stirring the resulting mixture. However, it is also within the scope of the invention to spray the noble metal salt solution onto the first oxidic substrate material or to add the first oxidic substrate material to a noble metal salt solution, followed by stirring the resulting mixture. Preferably, the resulting suspensions are stirred for a period of one hour up to 30 hours after step d) and, in particular, after step c) and step d).

Preferably, the pH value of the suspension is set to a range of 4 to 10 in step c) of the method according to the invention. In a preferred embodiment, the pH value is set to a range of 4 to 7, in particular a range of 4.5 to 6.5. In an alternative preferred embodiment, the pH value is set to a range of 7.5 to 10, in particular a range of 7.5 to 8.5. If the pH value is outside of these ranges, substrate materials that have the composition according to the invention applied to them, if applicable, may be attacked.

Surprisingly, it has been found that the application of the noble metal salt onto the first oxidic substrate material during the contacting step is particularly effectively within these ranges and ensures that the noble metal salt(s) adhere well to the first oxidic substrate material. Outside of the pH range according to the invention, the noble metal salt(s) may detach again from the oxidic substrate material.

It is within the scope of the invention to regulate the pH value of the suspension only after contacting the noble metal salt solution with the first oxidic substrate material. It is also within the scope of the invention to first set the pH value of the noble metal salt solution before contacting it with the substrate material. The scope of the invention also includes first setting a suspension of substrate material and solvent to a certain pH value and then adding the noble metal salt solution to the suspension.

In this context, the pH value of the suspension may be set using known materials, in particular ammonia and/or an aqueous sodium carbonate solution. It is preferable to set the pH value of the suspension using an aqueous sodium carbonate solution. Surprisingly, it has been found that the CO surface area of the catalyst in this case is 10 m²/g or more, in particular 12 m²/g or more.

The method according to the invention may be performed at room temperature, i.e., at a temperature of 20° C. However, steps a) to d) may just as well be performed at a lower or higher temperature than room temperature. Preferably, the temperature is in the range of 10° C. to 90° C., in particular in the range of 15° C. to 50° C., more particularly in the range of 20° C. to 40° C. Preferably, the reaction proceeds at room temperature, since there are then no costs related to changing the temperature, for example by means of cooling or heating facilities. The limiting factors in the selection of the temperature are the selection of the liquid used to produce the suspension in step c) as well as the selection of the noble metal salt solution. Neither the liquid of the suspension nor the solvent of the noble metal salt solution should evaporate at this temperature.

In step d) of the method according to the invention, a second oxidic substrate material is introduced into the suspension obtained in step c). The second oxidic substrate material may be different from the first oxidic substrate material that is already present in the suspension. However, it is also within the scope of the invention to use the same substrate material in step d) as the one provided in step a). The first and/or second oxidic substrate materials are selected as a function of the selection of the respective other oxidic substrate material and of the later use of the composition obtained according to the invention.

The suspension obtained in step d) may be subjected to filtration to remove excessive liquid. Usually, catalytically active compositions are applied onto substrate materials prior to use. To render the coating of the substrate materials with the composition economical, the solids content of the suspension should be in the range of 20 to 40 wt. %. In the method according to the invention, the solids concentration of the suspension in step d) is markedly lower. The solids content may be increased to the range needed for the coating to be economical by filtration.

In certain applications, the particle size of the first and/or second oxidic substrate material may also be relevant. In these cases, a size selection of the first and/or second oxidic substrate materials may be attained by filtration of the suspension.

If the composition according to the invention is to be used for exhaust gas after-treatment of combustion engines, it has been surprisingly found that the exhaust gases from combustion engines are decomposed particularly well in the composition according to the invention having a particle size d90 in the range of 10 μm to 35 μm, preferably in the range of 15 μm to 30 μm, particularly preferably in the range of 19 μm to 24 μm. In particular for lean conditions, the emission of hydrocarbons, carbon monoxide, and nitrogen oxides may be decreased markedly as compared to compositions having particle sizes of less than 10 μm. Specifically the emission of carbon monoxide decreases markedly if the motor is operated at rich conditions. Concurrently, the emission of carbon dioxide may be kept low as well. d90 denotes a particle size in which 90% of the particles are smaller than the d90value.

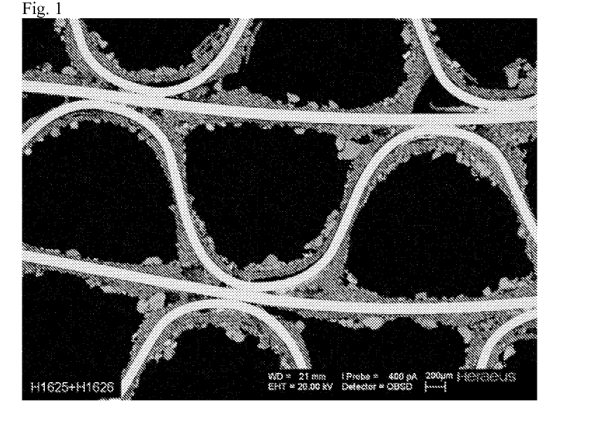

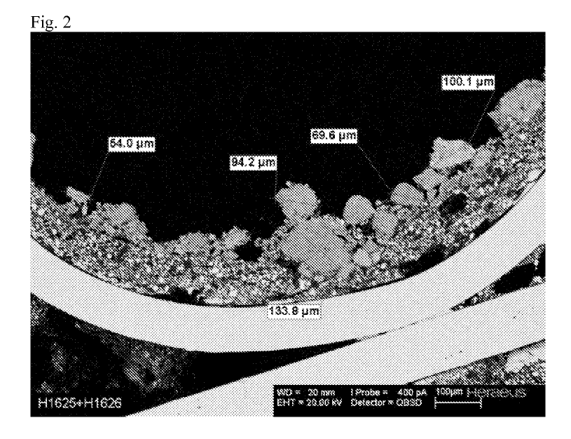

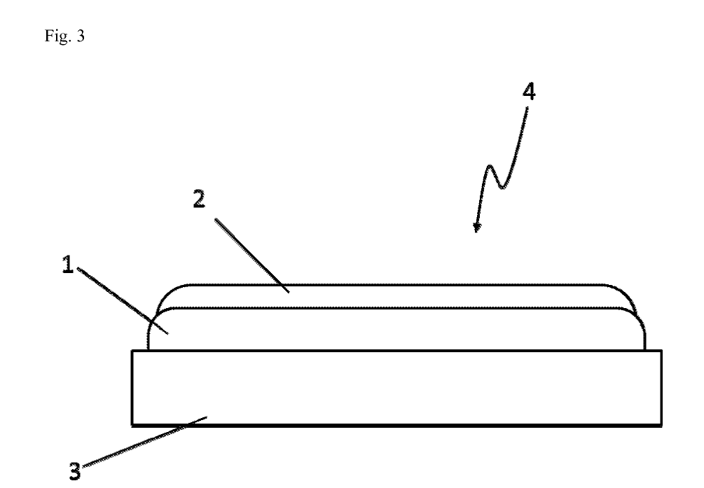

If the particle size d90 is above 35 μm, the use in a catalyst is no longer beneficial. If a catalyst substrate is coated with a composition of this large particle size, the particles are no longer present in mutually interlinked form. Rather, agglomerates are formed. For this purpose, a first composition produced according to the invention was applied onto a catalyst substrate. Subsequently, a second catalytically effective composition produced according to the invention was applied onto the first composition on the catalyst substrate. FIG. 1 shows a scanning electron micrograph (SEM), in which the particle size d90 of the second layer is higher than 35 μm. The particle size of the individual particles in the second layer can be seen in FIG. 2. FIG. 2 shows details from FIG. 3.

The particle size of the composition may also be defined by means of the particle sizes d50 and d10. Accordingly, 50% and 10%, respectively, of the particles are smaller than the value given. Preferably, the composition has a particle size d50 in the range of 2.5 μm to 11.5 μm, more preferably 4 μm to 10 μm, particularly preferably 5.5 μm to 8.5 μm. Also preferably, it has a particle size d10 in the range of 1 μm to 4 μm, more preferably 1 μm to 2 μm, particularly preferably 1.0 μm to 1.8 μm. The particle size of the oxidic substrate materials was determined in accordance with the particle size of γ-Al₂O₃.

Accordingly, the method according to the invention facilitates the production of a catalytically effective composition. The composition according to the invention comprises a CO surface area of 6 m²/g or more, preferably 7 m²/g or more, particularly preferably 7.5 m²/g or more. Catalytically effective compositions having a CO surface area this large are not known from the prior art. In this context, the large CO surface area enables better conversion as compared to catalysts known from the prior art.

The catalytically effective composition according to the invention can be used, for example, in a catalyst for treatment of exhaust gases of combustion engines. It is customary in exhaust gas after-treatment of combustion engines to use multilayer catalysts.

These multilayer catalysts are basically described in the prior art. Accordingly, DE 10 024 994 A1 describes a catalyst in which the noble metals are applied onto a substrate in separate layers. The catalyst comprises a first coating layer formed on a heat-resistant substrate and a second coating layer formed on the first coating layer. The first coating layer contains aluminum oxide bearing palladium; the second coating layer contains cerium zirconium complex oxides bearing both platinum and rhodium.

For improvement of the decomposition of exhaust gases in a catalyst, WO 98/09726 A1 describes a coating for a catalyst which comprises a first substrate for a first noble metal component and a second substrate for a second noble metal component, in which the average particle size of the second substrate is larger than the average particle size of the first substrate. This causes different noble metals to be separated from each other in operation of the catalyst. For this purpose, the respective noble metal components are affixed on their substrates and then ground to the desired size. The frits thus obtained are then applied onto a substrate to obtain a layer which comprises the smaller particles, in particular, in the lower region and the larger particles, in particular, in the upper region.

Different size distributions in a catalytically active layer are also known from EP 0556554 A2. Here, the coating dispersion that can be applied onto a catalyst comprises solids that have a multi-modal grain size distribution with different grain fractions.

Surprisingly, it has been found that a catalyst comprising the composition according to the invention leads to lesser emission of nitrogen oxides, carbon monoxide, and hydrocarbons during the exhaust gas after-treatment of combustion engines.

In another embodiment, the present invention relates to the use of the composition in a multilayer catalyst for exhaust gas after-treatment of combustion engines and to the multilayer catalyst. A corresponding multilayer catalyst for exhaust gas after-treatment of combustion exhaust gases comprises a substrate structure comprising channels for passage of gases, wherein at least some of the channels comprise an exhaust gas inlet situated upstream with respect to the flow direction of the exhaust gases and a gas outlet situated downstream. At least some of the channels comprise a first layer (1) that is applied at least to the internal surface and a second layer (2) that at least partially covers the first layer (1), wherein the first layer (1) and the second layer (2) comprise a catalytically effective composition according to the invention.

Preferably, the first layer (1) and the second layer (2) each comprise the composition according to the invention, in particular they consist of the composition according to the invention. In this context, the first layer (1) and the second layer (2) may comprise the same or different compositions. A multilayer catalyst in which the first layer (1) and the second layer (2) comprise different compositions is preferred since this allows the compositions of the layers to be selected according to their tasks. In this context, it is preferred to have both layers produced according to the invention.

Hereinafter, any reference in the description to first layer (1) shall be understood to mean the first catalytically effective layer (1). The same applies to the second layer (2) which shall be understood to mean the second catalytically effective layer (2). “Composition of the first layer (1)” shall be understood to mean the catalytically effective composition according to the invention which is applied onto the substrate structure as the first layer (1). “Composition of the second layer (2)” shall be understood to mean the catalytically effective composition according to the invention which is applied onto the substrate structure as the second layer (2).

A multilayer catalyst according to the invention does not only lead to improved decomposition of the pollutants from the exhaust gas. In addition, the light-off temperature, at which the conversion rate of hydrocarbons HC, carbon monoxide CO, and nitrogen oxides NOₓ is 50%, is lower. This is the case at both rich and lean motor conditions, as shown in Tables 3 and 4 below.

Table 3 shows each of the compositions of the first layer (1) and the second layer (2) of a multilayer catalyst according to the invention. Moreover, column 2 shows the total amount of noble metal present in the catalyst. This shall be understood to mean the total amount of all noble metals that are present in the first and in the second layer taken together. The numbers are given in units of wt. % relative to the sum of the first and second composition adding up to 100 wt. %.

Column 5 describes the composition of the first layer. This layer comprises at least a first noble metal salt, a first oxidic substrate (first oxidic substrate material), and a second oxidic substrate (second oxidic substrate material). Column 6 then describes the second layer, which also comprises at least one noble metal salt, as well as a first and a second oxidic substrate (oxidic substrate material). If the Table below specifies just one oxidic substrate, the first oxidic substrate and the second oxidic substrate are identical. If the materials are different, they are separated by a “+.” The assignment of the substrate materials is evident from Table 2. The fraction of the substrate materials in units of wt. %, relative to the composition of the first layer (1) or, as the case may be, the composition of the second layer (2) being 100 wt. %, is given in parentheses. The difference in fractions making up 100 wt. % corresponds to the binding agent fraction in the composition. A binding agent in the present invention is gamma-aluminum oxide (γ-Al₂O₃). In this context, it is also feasible, according to the invention, to use a compound that is converted into γ-Al₂O₃ in the course of the production method. For example boehmite can be used as binding agent. The nitrate salt of the noble metal specified was used as noble metal salt.

The third column specifies the total amount of first and second composition that is being applied onto the substrate structure. The numbers given are grams of first and second composition per liter of void volume of the substrate structure. Column 4 specifies the mass ratio of the noble metals, Pt:Pd:Rh. The composition of the first layer (1) and second layer (2) were produced according to the invention.

TABLE 3

| | | | | 1st layer | 2nd layer |
|---|---|---|---|---|---|
| | Total | Amount of | | (noble metal/first | (noble metal/first |
| | amount of | first and | Mass ratio | oxidic substrate | oxidic substrate |
| | noble metal | second | of noble | [wt. %] + second | [wt. %] + second |
| | coating | composition | metals, | oxidic substrate | oxidic substrate |
| Catalyst | (Pt + Pd + Rh) | [g/L] | Pt:Pd:Rh | [wt. %] | [wt. %] |
| Cat. 5 | 1.41 wt. % | 150 | 02:35:3 | Pd/no. 3 (26) + | PtRh/no. 4 (100) |
| (inventive) | | | | no. 2 (74) | |
| Cat. 6 | 1.06 wt. % | 150 | 02:35:3 | Pd/no. 3 (30) + | PtRh/no. 1 (100) |
| (inventive) | | | | no. 2 (70) | |
| Cat. 7 | 1.06 wt. % | 150 | 02:35:3 | Pd/no. 3 (30) + | PtRh/no. 1 (100) |
| (non-inventive) | | | | no. 2 (70) | |
| Cat. 8 | 1.41 wt. % | 150 | 02:35:3 | Pd/no. 3 (25) + | PtRh/no. 4 (100) |
| (non-inventive) | | | | no. 2 (70) | |
| Cat. 9 | 1.06 wt. % | 150 | 02:35:4 | Pd/no. 3 (30) + | PtRh/no. 1 (100) |
| (inventive) | | | | no. 2 (70) | |
| Cat. 10 | 1.41 wt. % | 150 | 02:35:4 | Pd/no. 3 (26) + | PtRh/no. 4 (100) |
| (inventive) | | | | no. 2 (74) | |
| Cat. 11 | 1.06 wt. % | 150 | 02:35:4 | Pd/no. 3 (30) + | PtRh/no. 1 (100) |
| (non-inventive) | | | | no. 2 (70) | |
| Cat. 12 | 1.41 wt. % | 150 | 02:35:4 | Pd/no. 3 (25) + | PtRh/no. 4 (100) |
| (non-inventive) | | | | no. 2 (70) | |

The multilayer catalysts having the compositions shown in Table 3 were tested for their catalytic properties in the after-treatment of combustion exhaust gases. Table 4 shows the results of the exhaust gas tests. The exhaust gas levels were determined in accordance with the Euro-3 standard (test cycle: cycle specified in ordinance ECE R40) in all examples. The exhaust gas levels are therefore given in units of % conversion.

TABLE 4

| | | | | | | Light-off | | |
|---|---|---|---|---|---|---|---|---|
| | | Exhaust gas levels | | | | temperature | | |
| | | [% conversion] | | | | [° C.] | | |
| | | (simulated cycle) | | | | (50% conversion) | | |
| Composition | Motor conditions | NO | CO | HC | Temperature [° C.] | HC | CO | NO |
| Cat. 5* | lean | 51 | 77 | 85 | 250 | 243 | 222 | — |
| Cat. 6* | lean | 36 | 55 | 40 | 250 | 268 | 245 | — |
| Cat. 7 | lean | 21 | 42 | 30 | 250 | 268 | 256 | — |
| Cat. 8 | lean | 51 | 73 | 66 | 250 | 280 | 248 | — |
| Cat. 9* | rich | 42 | 74 | 73 | 300 | 333 | 322 | 270 |
| Cat. 10* | rich | 46 | 74 | 94 | 300 | 300 | 246 | 241 |
| Cat. 11 | rich | 31 | 72 | 72 | 300 | 351 | 355 | 312 |
| Cat. 12 | rich | 48 | 74 | 82 | 300 | 334 | 342 | 265 |

*first composition, produced according to the invention, in the catalyst

In lean operation of the motor, the nitrogen oxides are not decomposed completely since the requisite reducing agents are already oxidized. Therefore, it is no longer possible to determine the light-off temperature in this case. The exhaust gas levels are given in units of % conversion. The measurement is performed in a simulated cycle. By simulating the real operating cycle, it is feasible to change the exhaust gas composition in a manner of seconds. The higher the conversion attained, the better the result.

Surprisingly, it has been found that the conversion rate of the pollutants present in the exhaust gas is higher with a catalyst according to the invention (catalysts 5 and 6, 9 and 10) as compared to conventional catalysts (catalysts 7 and 8, 11 and 12). Likewise, the light-off temperature, at which 50% of the pollutants in the exhaust gas (nitrogen oxides NO_{R}, carbon monoxide CO, and hydrocarbons HC) are converted, is lower with a catalyst according to the invention than with a catalyst known from the prior art.

A larger CO surface area of the composition according to the invention and of the catalyst according to the invention obtained from it indicates that the number of active noble metal centers, in particular Pd centers, is higher and/or that the active noble metal surface is larger, which increases the oxidation activity of exhaust gas emissions, in particular of CO emissions. This is important, in particular, for carburetor-driven motorcycles which comprise, in some case extreme, fluctuations of lambda in the exhaust gas and therefore generate, to some case, high CO emission peaks, which are to be balanced out as efficiently as possible. The noble metal centers arise through reduction of the noble metal salts provided during the production of the catalyst.

Surprisingly, it has been found that a composition produced according to the invention also exhibits a high oxygen storage capacity. The oxygen storage capacity is determined using the method described above. A composition exhibiting a high oxygen storage capacity means that it is capable of balancing out even more extensive lambda fluctuations in the exhaust gas after-treatment of combustion engines. In order to determine the oxygen storage capacity, a multilayer catalyst was produced, in which the first layer (1) on the substrate structure contains a composition produced according to the invention. The second layer (2) contains a catalytically active composition that comprises platinum and rhodium.

Table 5 below summarizes the compositions of the various multilayer catalysts. The composition of the oxidic substrates is shown in Table 2. The number given in parentheses is the fraction in units of wt. %. The difference making up 100 wt. % (100 wt. % corresponds to the composition of the first layer (1) and/or of the second layer (2)) corresponds to a binding agent that may be present in the form of γ-Al₂O₃. The binding agent may also comprise a boehmite, which is converted into γ-Al₂O₃ during the production method of the multilayer catalyst.

Column 2 also shows the total coating amount of noble metals. The number given in wt. % is relative to the sum of the first and second composition for the first and/or second layer being 100 wt. %. It is evident from the concentration shown in column 5 that catalysts 15 and 16 are catalysts according to the invention. In the catalysts according to the invention, both the first layer (1) and the second layer (2) were produced according to the method according to the invention. The number given is the concentration of the noble metals in the corresponding noble metal salt solution. Accordingly, in the case of catalyst 13, for example, the concentration of palladium in the noble metal salt solution was 7 wt. %. The concentration of platinum and rhodium in the noble metal salt solution for production of the second layer was also 7 wt. %. The numbers for other catalysts are given accordingly. The oxygen storage capacity was determined using the method described above and is given in units of μmol CO per gram of catalytically active composition.

TABLE 5

| | | 1st layer | 2nd layer | | |
|---|---|---|---|---|---|
| | | (noble metal/ | (noble metal/ | | |
| | | first oxidic | first oxidic | | |
| | Total coating | substrate | substrate | Concentration | |
| | amount of | [wt. %] + second | [wt. %] + second | of noble | Oxygen |
| | noble metals | oxidic | oxidic | metal in the | storage |
| | (Pt + Pd + Rh) | substrate | substrate | noble metal | capacity |
| Catalyst | [wt. %] | [wt. %] | [wt. %] | salt solution | [μmol/g] |
| Cat. 13 | 1.41 | Pd/ | PtRh/ | 7 wt. % | 537 |
| | | no. 2 (25) + | no. 4 (100) | | |
| | | no. 3 (70) | | | |
| Cat. 14 | 1.41 | Pd/ | PtRh/ | 0.035 wt. % | 568 |
| | | no. 2 (25) + | no. 4 (100) | | |
| | | no. 3 (70) | | | |
| Cat. 15* | 1.41 | Pd/ | PtRh/ | 0.007 wt. % | 729 |
| | | no. 2 (25) + | no. 4 (100) | | |
| | | no. 3 (70) | | | |
| Cat. 16* | 1.41 | Pd/ | PtRh/ | 0.0035 wt. % | 835 |
| | | no. 2 (25) + | no. 4 (100) | | |
| | | no. 3 (70) | | | |

*catalyst according to the invention

The total thickness of first layer (1) and second layer (2) is preferably 100 μm or less, particularly preferably 50 μm or less. At these layer thicknesses, the exhaust gas can flow through the catalyst unimpeded. In this context, the exhaust gas still contacts the catalytically effective compositions of the individual layers to a sufficient degree. In the scope of the present invention, the total thickness of the layers shall be understood to be the average thickness on the wall of the substrate structure. Only planar surfaces of a wall are taken into account in the determination of the thickness of the layers in this context. Regions at which two or more walls hit or touch against each other, which are associated with the formation of hollow spaces of a triangle-like shape, are not taken into account in the determination of the total thickness of the layers. The layer thickness was determined by scanning electron microscopy.

Preferably, the first layer (1) and the second layer (2) comprise different catalytically effective compositions according to the invention. In the multilayer catalyst, the second layer (2) at least partially covers the first layer (1). In this context, the second layer (2) may preferably cover at least 50%, more preferably at least 60%, even more preferably at least 75%, in particular at least 85%, specifically at least 90% or at least 95% of the surface of the first layer (1). FIG. 3 shows a schematic depiction of a corresponding embodiment.

In a preferred embodiment, the multilayer catalyst according to the invention for exhaust gas after-treatment of combustion engines comprises a composition according to the invention in the first layer (1) that comprises palladium as noble metal, and a composition according to the invention in the second layer (2) that comprises platinum and/or rhodium. It has been found that the effect of the noble metals in the conversion of the exhaust gases is particularly high if these are present in separate layers. Specifically palladium should be present separate from platinum and rhodium. The catalyst heats up in operation and as a result, aggregates of the noble metals may be formed. Specifically palladium tends to form aggregates. If palladium is present in a layer together with platinum and/or rhodium, mixed aggregates are formed, which have a clearly lower catalytic activity as compared to the pure noble metals.

If a multilayer catalyst is to be produced by the method according to the invention, the method preferably comprises, in step b), using a noble metal salt solution comprising 0.01 wt. % or less, preferably 0.008 wt. % or less, particularly preferably 0.007 wt. % or less palladium, for producing a first catalytically active composition. In an also preferred method, step b) comprises using a noble metal salt solution comprising 0.01 wt. % or less, preferably 0.008 wt. % or less, particularly preferably 0.007 wt. % or less platinum and/or rhodium, for producing a second catalytically effective composition.

The first layer in a multilayer catalyst according to the invention preferably comprises a palladium fraction of 0.05 wt. % to 10.00 wt. %, particularly preferably 0.10 wt. % to 10.00 wt. %, even more particularly preferably 0.50 wt. % to 5.00 wt. %, relative to the total composition of the first layer (1) being 100 wt. %.

The second layer (2) preferably comprises a platinum and/or rhodium fraction of 0.05 wt. % to 2.00 wt. %, particularly preferably 0.1 wt. % to 1.0 wt. %, more particularly preferably 0.2 wt. %, relative to the total composition of the second layer (2) being 100 wt. %. The fraction of platinum and/or rhodium relates to the entire substance content of the second layer (2).

According to the invention, the second layer (2) may comprise just platinum, just rhodium or both platinum and rhodium. If both platinum and rhodium are present, the ratio of platinum to rhodium preferably is in the range of 1:5 to 5:1, particularly preferably 2:3.

The second layer (2) may comprise, for example, a cerium-zirconium oxide as first oxidic substrate material. This material assumes the role of an oxygen storage material in the catalyst. Preferably, the material comprises a cerium-rich cerium-zirconium oxide, in which the fraction of cerium oxide CeO₂, relative to the total oxide, is at least 50 wt. % and the fraction of zirconium oxide ZrO₂ is lower than the fraction of cerium oxide CeO₂. The oxygen storage material may comprise a CeO₂ fraction in the range of 50 wt. % to 80 wt. % and a ZrO₂ fraction in the range of 10 wt. % to 40 wt. %, in particular 60 wt. % CeO₂ and 30 wt. % ZrO₂, each relative to the total composition of the second layer (2) being 100 wt. %, i.e., the entire substance content of the second layer (2) being 100 wt. %.

The thermal stability of the oxygen storage material is relevant for the conversion rate attained by the multilayer catalyst. The oxygen storage material is a porous material. Pure cerium oxide also has a porous structure. The noble metal is applied onto the oxygen storage material. In operation, the exhaust gas flows onto the oxygen storage material of the catalytically effective layers. Since the surface is porous, the flows become turbulent, which leads to improved contact between the catalytically effective layers and the exhaust gases to be treated.

If the pore size of the oxygen storage material is too small, the exhaust gas flows along the surfaces of the oxygen storage material. However, the catalytically effective noble metal is situated not only on the surface, but also on the inside of the oxygen storage material in the pores thereof. If the pore size is too small, the noble metal situated on the inside is not available during operation for treatment of the exhaust gas. Mainly, the pore volume and the pore radius, as well as the size of the orifice of the pores, are crucial in this context. These must be maintained, at least in part, during both production and in operation, and have at least a minimal size. The pore volume usually is in the range of 0.2 to 10 ml/g, in particular in the range of 0.3 to 0.8 ml/g. The average pore radii are approx. 5 to 20 nm, in particular 7 to 12 nm.

In the preferred cerium-zirconium oxide according to the invention, the structure of pure cerium oxide is interrupted by the zirconium oxide. This leads to a change of the pore volume and pore radius of the oxygen storage material. In particular, the thermal stability of the structure is increased. The pores remain stable even during operation at temperatures above 500° C. Therefore, in operation, the entire amount of noble metal present is available for reaction with the exhaust gas. It has been found that a fraction of at least 10 wt. % zirconium oxide in the oxygen storage material provides for sufficient thermal stability. However, a fraction of zirconium oxide exceeding 45 wt. % leads to a decrease of the oxygen storage capacity of the oxygen storage material.

During the production and/or in operation of a multilayer catalyst, a catalyst is exposed to high temperature stress. In order to determine the stability of the pore structure of the oxygen storage materials, these are subjected to a temperature of 1000° C. for a period of approx. 3 to 8 hours. The BET surface area is determined following this temperature treatment. Oxygen storage materials consisting of cerium oxide and zirconium oxide comprise a BET surface area of 20 m²/g or less after a temperature treatment at 1000° C.

However, it has been found that the BET surface area of the oxygen storage materials may be set. In order to obtain a larger BET surface area of 30 m²/g or more after a temperature treatment at 1000° C., the oxygen storage material of the catalytically effective composition of the second layer (2) preferably further comprises one or more metals selected from the group consisting of neodymium, praseodymium, lanthanum, and hafnium. Preferably, the metals are present in the form of the oxides thereof. In this context, the fraction of the respective metal oxides may be 2 wt. % to 10 wt. %, preferably 3 wt. % to 7 wt. %, relative to 100 wt. % of the oxygen storage material.

Doping the oxygen storage material at such levels leads to the oxygen storage material showing improved thermal stability. If the fraction is lower, no effect is detectable. Conversely, higher fractions of more than 10 wt. % do not increase the stability any further. Moreover, the addition of praseodymium, lanthanum, neodymium, and/or hafnium accelerates the incorporation and retrieval of oxygen into and from the oxygen storage material.

Table 6 below shows the corresponding BET surface area of different oxygen storage materials after temperature treatment at 1000° C. The oxygen storage materials No. 1 and No. 5 consist of CeO₂ and ZrO₂. These comprise a BET surface area of less than 20 m²/g. Doping with oxides of praseodymium, lanthanum, neodymium and/or hafnium increases the BET surface area after temperature treatment. Accordingly, the thermal stability of the oxygen storage materials is increased by the doping. The oxygen storage material is an oxidic substrate material according to the present invention. The oxygen storage material No. 1 corresponds to the oxidic substrate material No. 1 from Table 2.

TABLE 6

| | Oxygen storage material | | | | | | |
|---|---|---|---|---|---|---|---|
| | | | | | | | BET |
| | CeO₂ | ZrO₂ | Nd₂O₃ | La₂O₃ | Y₂O₃ | Pr₆O₁₁ | [m²/ |
| | [wt. %] | [wt. %] | [wt. %] | [wt. %] | [wt. %] | [wt. %] | g] |
| No. 1 | 60 | 30 | | 3 | | 7 | 49 |
| No. 6 | 70 | 30 | | | | | 17 |
| No. 7 | 56 | 39 | 5 | | | | 28 |
| No. 8 | 65 | 27 | | 8 | | | 30 |
| No. 9 | 60 | 25 | 5 | 2 | 8 | | 33 |
| No. 10 | 58 | 42 | | | | | 16 |
| No. 11 | 68 | 24 | | 5 | | 3 | 17 |

Accordingly, the properties of the catalytically active layer may be set by the amount of neodymium, praseodymium, lanthanum, and hafnium added to the oxygen storage material of the second layer (2). These materials may be used to influence, and set according to need, the thermal stability, oxygen storage capacity, and the rate of oxygen incorporation and retrieval.

The catalytically effective composition of the first layer (1) preferably comprises palladium. It further comprises an oxygen storage material that comprises one or more rare earth metals. Preferably, the oxygen storage material is a cerium-zirconium oxide (CeₓZr_{y}O_{z}). This oxide preferably comprises 50 wt. % to 80 wt. % CeO₂ and 10 wt. % to 40 wt. % ZrO₂, particularly preferably 60 wt. % CeO₂ and 30 wt. % ZrO₂, relative to the total composition of the first layer (1) being 100 wt. %.

As before, adding ZrO₂ to CeO₂ leads to improved thermal stability and thus to the multilayer catalyst having higher activity and a longer service life, as illustrated with regard to the oxygen storage material of the second layer (2).

Preferably, the catalytically effective composition of the first layer (1) comprises a fraction of the oxygen storage material of 40 wt to 90 wt. %, particularly preferably a fraction of 70 wt. %, relative to the total composition of the first layer (1) being 100 wt. %. The palladium fraction in this layer is preferably in the range of 0.5 wt. % to 5 wt. %.

The first layer (1) and/or the second layer (2) are preferably loaded with the corresponding catalytically effective composition in the range of 40 g/L to 150 g/L, particularly preferably 75 g/L. The loading indicates the amount of catalytically active composition applied relative to the void volume of the catalyst.

Preferably, the composition of the first layer (1) comprises an oxygen storage material and the composition of the second layer (2) comprises an oxygen storage material, in which the oxygen storage material of the composition of the first layer (1) differs from the oxygen storage material of the composition of the second layer (2). In this context, both the composition of the first layer (1) and/or the composition of the second layer (2) may further comprise γ-Al₂O₃, which preferably is doped with lanthanum oxide.

If the composition of the first layer (1) comprises γ-Al₂O₃, the fraction of γ-Al₂O₃ preferably is 10 wt. % to 60 wt. %, particularly preferably 30 wt. %, relative to the total composition of the first layer (1) being 100 wt. %. If the composition of the second layer (2) comprises γ-Al₂O₃, the fraction of γ-Al₂O₃ is preferably 10 wt. % to 30 wt. %, particularly preferably 10 wt. %, relative to the total composition of the second layer (2) being 100 wt. %. (2).

The fraction of γ-Al₂O₃ in the catalytically effective layer has an influence on the adhesion of the composition on the surface on the inside of the substrate. The first layer (1) is fully applied onto the substrate material of the multilayer catalyst according to the invention, whereas the second layer (2) is partially applied onto the first layer (1) and partially onto the substrate material. Therefore, the composition of the first layer (1) preferably comprises a higher fraction of γ-Al₂O₃ than the composition of the second layer (2). If the fraction of γ-Al₂O₃ in the composition of the second layer (2) exceeds 30 wt. %, the NOₓ conversion of the layer deteriorates. Accordingly, the NOₓ conversion of the multilayer catalyst according to the invention improves with increasing fraction of oxygen storage material in the second layer. By reducing the amount of oxygen storage material used in a catalyst according to the invention by half and replacing it with γ-Al₂O₃, the emission increases by approx. 25 to 30%. If oxygen storage materials according to the invention having γ-Al₂O₃ fractions of 30 wt. % or less are used, the emission of nitrogen oxides (NOₓ) is approx. 0.0099 g/km (grams of NOₓ per kilometer travelled). By reducing the amount of oxygen storage material by half, this value increases to 0.125 g/km.

Preferably, the γ-Al₂O₃ is lanthanum oxide La₂O₃-doped aluminum oxide. The La₂O₃ content, relative to the amount of Al₂O₃, is preferably in the range of 2 wt. % to 4 wt. %, particularly preferably 3 wt. %. The γ-Al₂O₃ preferably has a large BET surface. The BET surface area of γ-Al₂O₃ usually is approx. 200 m²/g. At high temperatures, as arise, for example, during the sintering during the production or in operation of a catalyst, this value decreases to approx. 40 to 50 m²/g. Doping with lanthanum oxide attains higher thermal stability of γ-Al₂O₃. Even after thermal treatment, the BET surface area of γ-Al₂O₃ doped according to the invention is still in a range of more than 70 m²/g, particularly preferably 90 m²/g.

Therefore, a multilayer catalyst according to the invention preferably comprises at least a first catalytically effective composition in a first layer (1), which comprises an oxygen storage material, La₂O₃-doped γ-Al₂O₃, and palladium, and a second catalytically effective composition in a second layer (2), which comprises an oxygen storage material, La₂O₃-doped γ-Al₂O₃, and platinum and/or rhodium. It is particularly preferred for the layers to consist of the corresponding compositions and it is particularly preferred for the compositions to consist of the specified components.

It is known from the prior art that rhodium situated on γ-Al₂O₃ is not available for the actual catalytic reaction or only to a limited degree. For this reason, platinum and/or rhodium in the composition of the second layer (2) are preferably present at least almost exclusively on the oxygen storage material. In the scope of the present invention, “almost exclusively” shall be understood to mean that at least 90%, preferably at least 95%, in particular at least 98%, specifically 99%, of the noble metal or noble metals is applied onto the oxygen storage material.

Surprisingly, it has been found that a balance between low light-off temperature and, concurrently, a large lambda window, may be attained if the palladium in the composition of the first layer (1) is not present almost exclusively on the oxygen storage material. In a preferred embodiment, a fraction of 30 wt. % to 40 wt. %, in particular 30 wt. %, of the palladium is situated on the γ-Al₂O₃, whereas 60 wt. % to 70 wt. %, in particular 70 wt. %, of the palladium is situated on the oxygen storage material. The palladium in the composition of the first layer (1) being applied almost exclusively onto the oxygen storage material has a detrimental effect on the light-off behavior of the multilayer catalyst according to the invention.

Preferably, the first layer (1) is essentially free of platinum and/or rhodium. Preferably, the second layer (2) is essentially free of palladium. In the scope of the present invention, “essentially free” shall be understood to mean that the weight ratio of palladium in the second layer (2) to palladium in the first layer (1) is preferably less than 1:10, more preferably less than 1:50, in particular less than 1:100 or less than 1:500, specifically 0, and that the weight ratio of platinum and/or rhodium in the first layer (1) to platinum and/or rhodium in the second layer (2) is preferably less than 1:10, more preferably less than 1:50, in particular less than 1:100 or less than 1:500, specifically 0.

The multilayer catalyst according to the invention comprises a substrate structure that comprises channels for passage of gases. A catalytically effective composition is applied to the internal surface of at least some of the channels. The substrate structure may comprise a ceramic or a metallic material. Preferably, it comprises a metallic material, in particular a metallic foil that comprises iron, chromium, and aluminum.

According to the invention, the metallic foil preferably comprises an aluminum fraction of 4 wt. % to 6 wt. % and a chromium fraction of 15 wt. % to 20 wt. %. If the aluminum fraction is more than 6 wt. %, the foil is not sufficiently flexible to be made into the desired shape of the substrate structure. If the aluminum fraction is less than 4 wt. %, the catalytically effective layer does not adhere to it. It has been found that homogeneous distribution of the aluminum in the foil is important. Due to the influence of heat and oxygen, aluminum oxide is formed and migrates to the surface of the metal foil. If the concentration of aluminum on the surface is very high, a rough surface structure is formed. This takes place with foils having an aluminum fraction of more than 6 wt. % and may be observed, for example, using a scanning electron microscope. The catalytically effective layer does not, or only poorly, adhere to said rough surfaces. This way, the catalyst is not ensured to be effective.

However, surfaces this rough may also form locally. If the aluminum is not distributed homogeneously in the metallic foil, sites at which the local aluminum concentration exceeds 6% can form rough surface regions to which the catalytically effective layer also cannot adhere.

The thickness of the metallic foil is preferably in the range of 30 μm to 200 μm; preferably the thickness is 100 μm. If the foil is thinner than 30 μm, it fails to have sufficient thermal stability and mechanical stability. If the foil is more than 200 μm in thickness, it is too rigid to be made into the desired shape. Moreover, the weight of the catalyst increases.

At least some of the channels of the substrate structure comprise the first catalytically effective layer (1), which is at least partially applied to the internal surface, and the second catalytically effective layer (2), which at least partially covers the first layer (1). In this context, the second layer (2) may cover at least 50%, preferably at least 60%, more preferably at least 75%, in particular at least 85%, specifically at least 90% or at least 95% of the surface of the first layer (1).

Preferably, the second layer (2) does not fully cover the surface of the first layer (1). Preferably, the second layer (2) covers a range of 60% to 95%, preferably of 70% to 90%, in particular 72% to 88%, of the surface of the first layer (1). It has been found that a ratio of the length of the first layer (1) along the flow direction to the length of the second layer (2) along the flow direction in a range of 1:2 to 2:1, preferably of 1:1.5 to 1.5:1, in particular of 1:1.2 to 1.2:1, is particularly preferred.

The conversion rate of the catalyst is lower if the second layer (2) covers the surface of the first layer (1) completely. Moreover, there is a negative effect when the first layer (1) is arranged downstream of the second layer (2) in flow direction, i.e., when there is no overlap of the two layers. In this type of zone coating, in which there is little or no overlap of the two layers, the CO emission is clearly higher than with layered coating, in which the first layer (1) and second layer (2) overlap according to the invention. Accordingly, the conversion of the exhaust gas flowing from the combustion engine gets poorer, as is evident from Table 7 below. The values in Table 7 are the emission levels, i.e., the amount of CO and NOₓ measured according to the official measuring cycle after passage through the catalyst. An overall deterioration of the emission results both upon zone coating and layered coating if the layers were aged, i.e., subjected to a temperature treatment. However, even after ageing, the emission limits of 2.0 g/km for CO and 0.150 g/km for NOₓ are still met.

TABLE 7
Conversion of Exhaust Gas

| Type of coating | CO [g/km] | NOₓ [g/km] |
|---|---|---|
| Zone coating | 0.507 | 0.094 |
| Layered coating | 0.368 | 0.107 |
| Zone coating, aged | 0.912 | 0.127 |
| Layered coating, aged | 0.625 | 0.127 |

Aside from the first layer (1) and the second layer (2), the multilayer catalyst according to the invention may comprise further catalytically active layers that contain compositions according to the invention. Preferably, the catalyst comprises two catalytically active compositions.

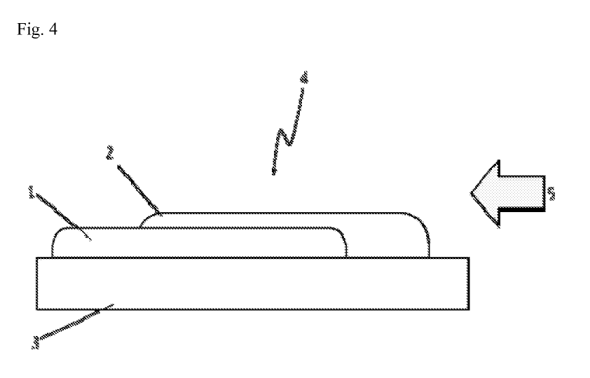

In a preferred embodiment, the first layer (1) and the second layer (2) are arranged appropriately such that the exhaust gas, in operation, contacts the second layer (2) first. This embodiment is shown in FIG. 4. When the exhaust gas flows from the combustion engine into the catalyst, it encounters the second layer (2) first in this embodiment. Nitrogen oxides may be reduced on this layer by removing oxygen from the reaction equilibrium. This reaction must proceed rapidly enough in order to attain a high conversion rate, which is made feasible by having platinum and/or rhodium present in the second layer (2). Subsequently, the exhaust gas flows to the first layer (1), which comprises palladium. Palladium present in the first layer (1) provides for slower incorporation and retrieval of oxygen into and from the oxygen storage material as compared to the second layer (2). However, the palladium increases the oxygen storage capacity of the oxygen reservoir of the first layer (1). Oxygen stored in the oxygen reservoir of the second layer (2) may therefore be released to the oxygen reservoir of the first layer (1). This prevents saturation of the oxygen reservoir of the second layer (2), which would lead to deteriorated reduction of the nitrogen oxides.

Due to the use of platinum and/or rhodium in the second layer (2) and the use of palladium in the first layer (1), the second layer (2), at operational conditions, has a higher activity with regard to the reduction of nitrogen oxides than the first layer (1).

Preferably, the multilayer catalyst according to the invention is a three-way catalyst. This is particularly preferred for exhaust gas after-treatment of four-cylinder petrol motors, in particular for exhaust gas after-treatment of motorcycles with four-cylinder petrol motors with a cubic capacity of up to 2,000 cm³. The operation of these is associated with a large fluctuation of lambda in a range of 0.7 to 1.3, in particular of 0.8 to 1.2. The multilayer catalyst according to the invention can convert the exhaust gases almost completely even with these lambda fluctuations.

A multilayer catalyst according to the invention may be used, for example, in small motors, motorcycles, automotive industry, utility vehicles, industrial and special applications, and marine applications.

According to the invention, a production method for the multilayer catalyst described above comprises the following steps:
a) providing a substrate structure;
b) providing a first catalytically effective composition according to the invention;
c) coating the substrate structure with the first catalytically effective composition to produce a first layer (1);
d) providing a second catalytically effective composition according to the invention;
e) coating the substrate structure with the second catalytically active composition to produce a second layer (2);
   The coating is performed to apply the first and the second composition appropriately such that the first layer (1) is at least partially covered by the second layer (2).

Preferably, the first layer (1) and the second layer (2) are arranged appropriately such that the exhaust gas, in operation, contacts the second layer (2) first.

The substrate structure may be annealed together with the first composition after coating with the first catalytically effective composition and before coating with the second catalytically effective composition. Preferably, this takes place at a temperature from 500° C. to 900° C., more preferably from 650 to 850° C., most preferably at 750° C. However, it is also within the scope of the invention to anneal the first layer at a first temperature T₁ in the range of 400° C. to 700° C. and then at a temperature T₂ in the range of 700° C. to 1,200° C. Even after the coating with the second catalytically effective composition, the substrate structure is preferably annealed at a temperature of 400° C. or more, in particular in a range of 400° C. to 700° C. The composition thus applied may be dried before the corresponding annealing. The drying takes place at temperatures in the range of 90° C. to 150° C., preferably at 110° C.

The term “coating” may be understood to encompass all types of coating known from the prior art, such as injecting, spraying or immersing.

In a further embodiment, the underlying object of the present invention is met by an exhaust gas after-treatment system that comprises one or more motors, in particular petrol motors, and one or more multilayer catalysts according to the invention. Preferably, a 4-cylinder petrol motor is connected via an exhaust gas feed to the multilayer catalyst in the exhaust gas after-treatment system. Preferably, the motor in the exhaust gas after-treatment system is a drive unit in a vehicle or a combined heat and power unit.

In a further embodiment, the underlying object of the present invention is met by a vehicle that comprises a multilayer catalyst according to the invention or an exhaust gas after-treatment system according to the invention. The vehicle preferably comprises a four-cylinder petrol engine and is selected from the group consisting of motorcycle, JetSki, trike, and quad bike. Preferably, the vehicle is a motorcycle.

According to the invention, the present application further comprises an exhaust gas after-treatment system and method. This method comprises the following elements:
a) flowing an exhaust gas over a surface comprising a substrate structure, a first catalytically effective layer (1) that is at least partially applied onto the substrate (3), and a second catalytically effective layer (2) that at least partially covers the first layer (1), in which the first layer (1) and the second layer (2) comprise a catalytically effective composition; and
b) contacting the exhaust gas flow with the second layer (2) and the first layer (1).
   Preferably, the second layer (2), at operating conditions, has a higher activity with regard to the reduction of nitrogen oxides (NOₓ reduction) as compared to the first layer (1). The first layer (1) and the second layer (2) are preferably configured appropriately such that the flow of exhaust gas reaches and contacts the second layer (2) first.

Preferably, this concerns an exhaust gas after-treatment method for the combustion exhaust gases of a 4-cylinder petrol motor.

### Exemplary Embodiments

### 1. Production of a Catalytically Active Composition

To produce a composition according to the invention, 140 g of oxidic substrate material No. 5 were first stirred in 300 ml fully deionized water at room temperature.

An aqueous palladium nitrate solution was diluted with fully deionized water such that the concentration of noble metal in the solution was 0.002 wt. %. Droplets of this noble metal salt solution were then added to the oxidic substrate material while stirring. The pH value was maintained in a range of 4 to 5. The pH value was adjusted with ammonia.

Then, 60 g of oxidic substrate material No. 2 were added and the resulting dispersion was stirred again. The dispersion thus obtained was subjected to filtration. The composition corresponds to composition 2 from Table 1.

Composition 1 from Table 1 was produced accordingly, except for the concentration of Pd in the noble metal salt solution being 7 wt. %.

The production of composition 4 was analogous to the production of composition 1, except that the oxidic substrate materials specified in Table 1 were used.

### 2. Production of a Catalytically Active Composition

To produce composition 3 according to the invention, a composition was produced analogous to the method described with reference to composition 2. The selection of the oxidic substrate materials was based on Table 1. The pH value of the solution was adjusted with a sodium carbonate solution (12.9 g sodium carbonate in 100 ml of water) rather than with ammonia. The pH values was in the range of 7.5 to 8. After addition of the second oxidic substrate, the mixture was stirred and then subjected to filtration.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for producing a catalytically effective composition for catalysts, comprising:
a) providing a first oxidic substrate material;
b) providing a noble metal salt solution containing one or more noble metal salts, wherein a concentration of noble metal in the solution is 0.01 wt. % or less, relative to the total solution being 100 wt. %;
c) producing a suspension by contacting the first oxidic substrate material with the noble metal salt solution; and
d) introducing a second oxidic substrate material into the suspension obtained in step c).

2. The method according to claim 1, wherein the first and the second oxidic substrate materials may be the same or different from each other.

3. The method according to claim 1, wherein at least one of the first and the second oxidic substrate materials is selected from the group consisting of aluminum oxide, cerium-zirconium oxide, barium oxide, tin oxide, and titanium oxide.

4. The method according to claim 1, wherein a total amount of noble metal is in a range of 0.01 to 10 wt. %, relative to the total amount of first oxidic substrate material and noble metal being 100 wt. %.

5. The method according to claim 1, wherein the one or more noble metal salts is a salt of a platinum group metal.

6. The method according to claim 1, wherein the one or more noble metal salts is a nitrate salt.

7. The method according to claim 1, wherein a pH value of the suspension is set to a range of 4 to 10.

8. The method according to claim 7, wherein the pH value is set to a range of 4 to 7.

9. The method according to claim 1, wherein a pH value of the suspension is set using at least one of ammonia and an aqueous sodium carbonate solution.

10. The method according to claim 9, wherein the pH value is set using an aqueous sodium carbonate solution.

11. The method according to claim 1, wherein steps a) to d) are performed at a temperature in a range of 10° C. to 90° C.

12. The method according to claim 1, further comprising filtering the suspension obtained in step d).

13. A catalytically effective composition obtained by the method according to claim 1, wherein the composition has a CO surface area of 6 m²/g or more.

14. A multilayer catalyst comprising the catalytically effective composition according to claim 13.

15. A vehicle comprising the multilayer catalyst according to claim 14.
